(19) United States
(12) Patent Application Publication
(10) Pub. No.: US 2012/0144290 A1
(43) Pub. Date: Jun. 7, 2012

(54) Integrated Native HTML Rendering

(75) Inventors: Oliver Goldman, Los Altos, CA (US); Alexandru Chiculita, Bucharest (RO)

(73) Assignee: Adobe Systems Incorporated, San Jose, CA (US)

(21) Appl. No.: 12/960,127

(22) Filed: Dec. 3, 2010

(30) Foreign Application Priority Data
Dec. 2, 2010 (RO) A01270

(51) Int. Cl. G06F 17/00

(52) U.S. Cl. 715/234

(57) ABSTRACT

A computer-implemented method for integrated native HTML rendering includes generating, in an application, an instruction to a native HTML renderer to render HTML content on a display device, the instruction generated using a runtime having an API that allows use of only at least one specified feature of the native HTML renderer. The method includes rendering, using the native HTML renderer, the HTML content on the display device per the instruction.

### CROSS-REFERENCE TO RELATED APPLICATIONS

Under 35 U.S.C. §119, this application claims the benefit of priority from a patent application filed in Romania, serial number A01270, filed Dec. 2, 2010, the contents of which are incorporated herein by reference.

### BACKGROUND

This specification relates to content rendering. An application interface can be implemented using HTML (HyperText Markup Language). HTML can be used to implement various application features, such as text displayed in various styles, hyperlinks, and user interface controls, such as command buttons. Application output, including HTML content, can be rendered onto a display device. Rendering can be performed, at least in part and on some devices, by a GPU (Graphics Processing Unit).

### SUMMARY

The invention relates to content rendering.

In a first aspect, a computer-implemented method for integrated native HTML rendering includes generating, in an application, an instruction to a native HTML renderer to render HTML content on a display device, the instruction generated using a runtime having an API that allows use of only at least one specified feature of the native HTML renderer. The method includes rendering, using the native HTML renderer, the HTML content on the display device per the instruction.

Implementations can include any or all of the following features. The HTML content is rendered directly to a screen on the display device. The native HTML renderer has a plugin providing specific functionality, wherein rendering the HTML comprises making the specific functionality available in the application. The method further includes retrieving HTML code for the HTML content from the application, wherein the code is used in rendering the HTML content. The application, the runtime, the native HTML renderer and also another HTML renderer are implemented on a device, and wherein the runtime has another API for the application to access the other HTML renderer. The method further includes simulating the rendering of the HTML content on a device that has another HTML renderer and does not have the native HTML renderer. The method further includes configuring the API on the device so that the application accesses a selected HTML renderer instead of the other HTML renderer. The method further includes subsequently modifying the API to allow use of a new renderer functionality.

In a second aspect, a computer program product is tangibly embodied in a computer readable storage device and includes instructions that when executed by a processor perform a method. The method includes generating, in an application, an instruction to a native HTML renderer to render HTML content on a display device, the instruction generated using a runtime having an API that allows use of only at least one specified feature of the native HTML renderer. The method includes rendering, using the native HTML renderer, the HTML content on the display device per the instruction.

Implementations can include any or all of the following features. The HTML content is rendered directly to a screen on the display device. The native HTML renderer has a plugin providing specific functionality, and wherein rendering the HTML content comprises making the specific functionality available in the application. The method further includes retrieving HTML code for the HTML content from the application, wherein the code is used in rendering the HTML content. The application, the runtime, the native HTML renderer and also another HTML renderer are implemented on a device, and wherein the runtime has another API for the application to access the other HTML renderer. The method further includes simulating the rendering of the HTML content on a device that has another HTML renderer and does not have the native HTML renderer. The method further includes configuring the API on the device so that the application accesses a selected HTML renderer on the device instead of the other HTML renderer.

The method further includes subsequently modifying the API to allow use of a new renderer functionality.

In a third aspect, a system includes a display device, a native HTML renderer, a runtime having an API for the native HTML renderer, the API allowing use of only a specified feature of the native HTML renderer, and an application that is configured for using the API to instruct the native HTML renderer to render HTML content on the display device.

Implementations can include any or all of the following features. The system further includes a plugin in the native HTML renderer that provides specific functionality, and wherein rendering the HTML content comprises making the specific functionality available in the application. The system further includes another HTML renderer and another API in the runtime for the application to access the other HTML renderer. The system further includes a device that has another HTML renderer and does not have the native HTML renderer, wherein the system simulates the rendering of the HTML content on the device. The API on the device is configured so that the application accesses a selected HTML renderer on the device instead of the other HTML renderer.

Particular embodiments of the subject matter described in this specification can be implemented to realize one or more of the following advantages. An application written to run on multiple types of devices can access, at runtime, a native HTML renderer, enabling access to functionality specific to the native HTML renderer. An application written to run on multiple types of devices can generate application output that is rendered in a format that users of a particular type of device expect. Applications can access new renderer functionality as new renderer functionality becomes available. A runtime can provide HTML rendering capability to applications without incurring a code footprint cost of including an HTML renderer separate from a native HTML renderer.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-B are block diagrams of a display device.

FIG. 2 is a block diagram of a system where native HTML rendering is integrated.

FIG. 3 is a block diagram of another system where native HTML rendering is integrated.

Like reference numbers and designations in the various drawings indicate like elements.

### DETAILED DESCRIPTION

Application output can include HTML content. HTML content can be rendered, for example, by a native renderer specific to a particular device or a non-native renderer that can execute on multiple types of devices. Some application developers may wish to use a non-native renderer so that application output appears the same regardless of which device executes the application. Other application developers may wish to use a native renderer so that the application can access functionality specific to the native renderer. An API (Application Programming Interface) can be added to a runtime that allows developers to code an application that is executable on multiple types of devices, but that at run time causes a native renderer specific to the executing device to be invoked.

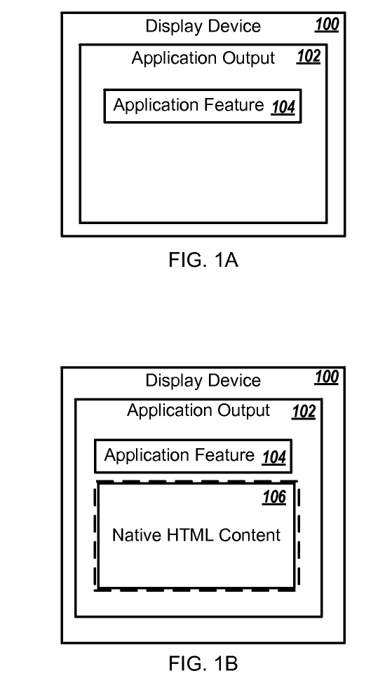

FIG. 1A is a block diagram of a display device 100. The display device 100 can be associated with one or more of a desktop computing device, laptop computing device, mobile computing device (e.g., mobile phone, smart phone, personal digital assistant (PDA)) or any other type of device. An application running on such associated device can output content that is rendered to a screen on the display device 100. For example, application output 102 can be rendered to the display device 100 by an application-specific renderer, and is illustrated as a rectangle in this example for simplicity.

The application output 102 can include one or more application features. For example, here the application output 102 includes an application feature 104 that is also illustrated as a rectangle. The application feature 104 can include one or more features. Such feature(s) can include plain text, styled text, an image, and/or a user interface control (e.g., command button, list box), to name a few examples.

HTML content can be generated and rendered on the display device 100. During execution of the application the HTML content can be generated based on one or more application events. For example, if the application feature 104 includes a user interface control, user interaction with the application feature 104 can generate an event. As another example, the application can generate an event based on a predefined condition, such as an event that occurs when a time interval lapses. As yet another example, the event can be a load event that occurs when the application initially loads or when the application output 102 is displayed.

In some implementations, the application can use one or more renderers. A renderer can be, for example, included in (e.g., packaged with) the application or can be otherwise accessible to the application. Some applications can use one renderer for HTML content and another renderer for non-HTML content. HTML content can be rendered, for example, by a non-native HTML renderer. In some situations, HTML content can also or instead be rendered by a HTML renderer that is native to the device, as will be illustrated in examples herein.

FIG. 1B is a block diagram of a display device 100. Similar to the display device 100 shown in FIG. 1A, the display device 100 shown in FIG. 1B includes application output 102 which includes an application feature 104. Native HTML content 106 is here shown inside the application output 102 and is shown within a dashed border to schematically illustrate that a different renderer is being used.

That is, in response to an event, the application can cause a native HTML renderer to be invoked, the native HTML renderer rendering HTML content on the display device 100. For example, the native HTML content 106 can be rendered in a style that users of a particular type of device expect.

In some implementations, the native HTML content 106 is rendered directly to a screen of the display device 100. As another example, the native HTML content 106 can be processed by a GPU and then sent to a screen of the display device 100. In other implementations, a software native HTML renderer can render an image in memory and the image can be sent to a screen of the display device 100.

In some implementations, rendering of the application output 102 can include using a display list. A display list can include a list of items to display, ordered in an order to be rendered (e.g., bottom to top). An application-specific renderer can process the display list and can render items in the display list in the order specified by the display list. In some implementations, the native HTML content 106 is not included in the display list.

In some implementations, after the application-specific renderer has rendered the items in the display list, a native HTML renderer can render the native HTML content 106 on top of other content rendered on the screen. This is sometimes referred to as performing the native HTML rendering above other rendering. By contrast, in other implementations, the native HTML content 106 is rendered before the items in the display list are rendered, or in other words, below the other items. In some implementations, the native HTML content 106 is rendered below some display list items and above other display list items.

Accordingly, the application invokes the native HTML renderer to generate some of the output for the device screen. Depending on the nature of the native HTML content 106 and the application output 102, the use of different renderers may not be apparent or even detectable to the user.

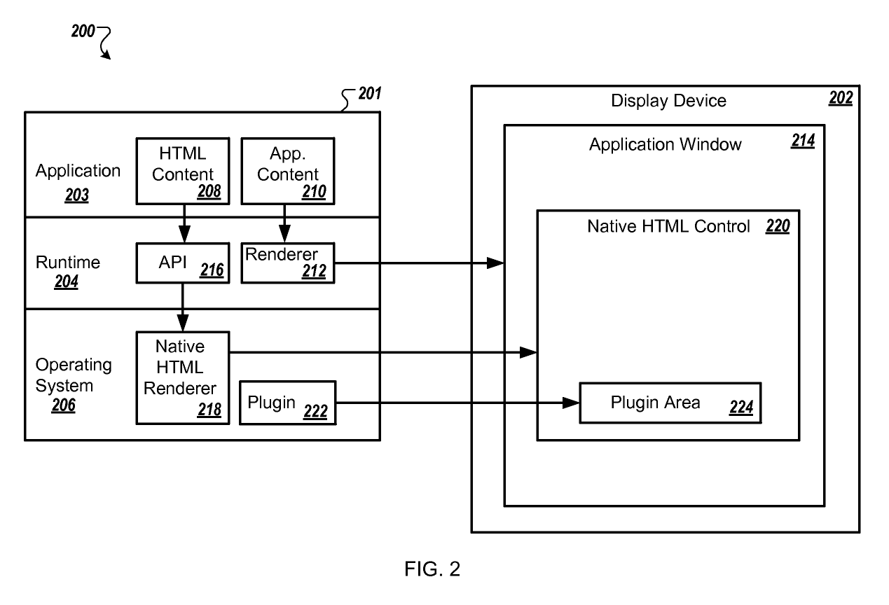

FIG. 2 is a block diagram of a system 200 where native HTML rendering is integrated. The system 200 includes a device 201 and an associated display device 202. The device 201 has an architecture that includes at least an application layer 203, a runtime layer 204, and an operating system layer 206. An application defined in the application layer 203 can include HTML content 208 and other application content 210.

The other application content 210 is here rendered by a renderer component 212 included in the runtime layer 204. For example, as shown on the display device 202, the application content 210 can be rendered to an application window 214 that is displayed on the display device 202. The application content 210 can include one or more application features.

The application can generate an instruction, using an API 216 included in the runtime layer 204, to invoke native rendering of HTML content. The instruction can be provided to a native HTML renderer 218 included in the operating system layer 206. The native HTML renderer 218 renders the HTML content 208 on the display device 202, such as in a native HTML control 220. The native HTML renderer 218 can render the HTML content 208 directly to a screen of the display device 202 and can write the HTML content 208 on top of, or below, other content rendered on the screen, to name two examples. The API 216 can facilitate communication between the application and the native HTML renderer 218. For example, the native HTML renderer 218 can communicate a status to the application which indicates whether any errors occurred during the rendering of the HTML content 208.

The API 216 is configured so that the application can use one or more specified features of the native HTML renderer 218. For example, the native HTML renderer has features that allow control of the size of the rendered content and its position on the screen. One or both of these features can be specified, meaning that the application will be able to use them. That is, the application that uses the API 218 can access any feature(s) included in such a specification, but cannot access any unspecified feature.

In some implementations, such a specification of available feature(s) is based on the ranges of features available in commonly used HTML renderers. That is, in the above example the features of controlling size and position of rendered content are found in all common HTML renderers, and it is therefore relatively safe to make those features available to the application (that is, to any application that uses this particular API). In some implementations, if a new feature becomes standard among common HTML renderers, the API is modified or replaced to accommodate also the new feature.

The HTML content 208 can, for example, be retrieved using a specified URL (Uniform Resource Locator). The URL can be forwarded, for example, to the native HTML renderer 218. As another example, the HTML content 208 can be specified HTML content, such as HTML content packaged with the application. That is, HTML code for the HTML content 208 can be retrieved from the application, forwarded to the native HTML renderer 218, and used by the native HTML renderer 218 in rendering the HTML content 208. The application can retrieve the HTML code, for example, from a server, from the package of the application, or from some other source available on the device 201, such as a file in disk or in other storage. As another example, the application can dynamically generate the HTML code at run time. In some implementations, the application can use the API 216 to retrieve or generate the HTML code.

On a particular type of device, the native HTML renderer 218 can provide rendering functionality specific to that type of device. That is, there can be one or more implementations of the native HTML renderer 218 for each device type supported by the API 216. The API 216 can be provided on multiple, different types of devices. The API 216 enables application code to run on multiple types of devices and to access native HTML rendering functionality when running on a particular type of device. An implementation of the API 216 for a particular device type can call one or more APIs provided by an implementation of the native HTML renderer 218 for that device type. The API 216 can be modified to allow use of a new renderer functionality. For example, the API 216 can be modified to include new renderer functionality if particular renderer functionality becomes available in a native HTML renderer 218 implementation for each device type supported by the API 216.

In some implementations, the API 216 can allow use of only a subset of features of the native HTML renderer 218. For example, the API 216 can allow the creation of the native HTML control 220 with a specified size and position. As mentioned, the API 216 can allow the native HTML renderer 218 to render the HTML content 208 into the HTML control 220. The API 216 can also forward notifications received from the native HTML renderer 218 to the application. For example, the native HTML renderer 218 can provide a notification that the user has navigated (e.g., by selecting a link) to HTML content other than the HTML content 208 displayed in the native HTML control 220.

Some features of the native HTML renderer 218 might not be made available to the application using the API 216. For example, in some implementations, the native HTML control 220 can be prevented from appearing on a display list. As another example, the API 216 might not include functionality provided by some but not all implementations of the native HTML control 218.

In some implementations, the native HTML renderer 218 has one or more plugins 222 that provide specific functionality, such as functionality specific to the device 201. HTML code associated with the HTML content 208 can reference one or more plugins 222. As part of rendering the HTML content 208, the native HTML renderer 218 can make the specific functionality available in the application. For example, functionality can be made available in a plugin area 224 included in the native HTML control 220. The plugin area 224 can be used, for example, to display output provided by the plugin 222. As another example, the plugin area 224 can include one or more input controls which can be used to provide input to the plugin 222.

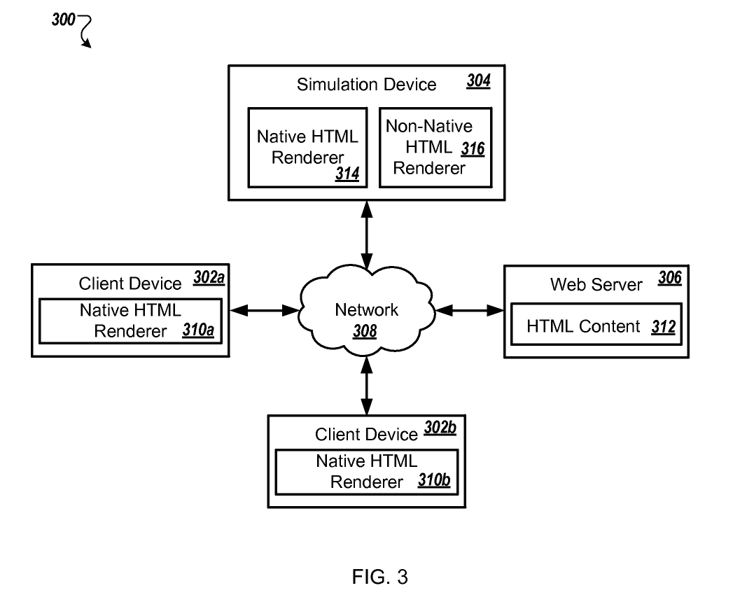

FIG. 3 is a block diagram of another system 300 where native HTML rendering is integrated. The system 300 includes client devices 302a and 302b, a simulation device 304, and a web server 306 connected using a network 308. The network 308 can be, for example, the Internet or some other public or private, wired or wireless network.

The client device 302a can be of a different device type than the client device 302b. For example, the client device 302a can be a desktop computing device and the client device 302b can be a mobile computing device. As another example, the client device 302a can be a first type of mobile computing device and the client device 302b can be a second type of mobile computing device. The client devices 302a and 302b include native HTML renderers 310a and 310b, respectively. A particular native HTML renderer 310 can provide renderer functionality specific to the type of the respective client device 302.

As described above, a particular native HTML renderer 310 can render HTML content on a display device associated with the respective client device 302, per an instruction generated using an API included in a runtime layer. The HTML content can be retrieved from the application, or the HTML content can be retrieved using a URL. For example, the URL may refer to HTML content 312 located on the web server 306. A client device 302 can request that the web server 306 send the HTML content 312 to the client device 302.

The simulation device 304 includes a native HTML renderer 314 and a non-native (e.g., cross-platform) HTML renderer 316. The simulation device 304 can be of a different device type than the client device 302a and the client device 302b. For example, the simulation device 304 can be a desktop computing device and the client devices 302a and 302b can each be mobile computing devices. In this example, the native HTML renderer 314 can provide rendering functionality specific to rendering HTML on a desktop computing device, which can be different functionality than the functionality of the native HTML renderers 310a and 310b which provide functionality for rendering HTML content on mobile devices.

The simulation device 304 can be used to simulate the rendering of HTML content on one or both of the client devices 302a and 302b. For example, the non-native HTML renderer 316 can be configured to simulate the functionality of the native HTML renderer 310a or the native HTML renderer 310b. A runtime layer of the simulation device 304 can include an API for accessing the non-native HTML renderer 316, which can be a different API than an API for accessing the native HTML renderer 314 (and which can also be a different API than an API used to access the native HTML renderers 310a and 310b). Application code can be configured to access the API for accessing the non-native HTML renderer 316 while in a simulation mode. The application code can be configured to access the API for accessing the respective native HTML renderer 310 when not in a simulation mode.

In some implementations, a developer can configure the runtime layer on the simulation device 304 to simulate features available on the client device 302a or on the client device 302b. For example, a developer can configure the runtime layer to simulate a specific type of device, and in response the runtime layer can configure the non-native HTML renderer 316 to enable or disable particular features of the non-native HTML renderer 316 based on the capabilities of a device of the specified device type.

Some portions of the detailed description are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method for integrated native HTML rendering, the method comprising:
generating, in an application, an instruction to a native HTML renderer to render HTML content on a display device, the instruction generated using a runtime having an API that allows use of only at least one specified feature of the native HTML renderer; and
rendering, using the native HTML renderer, the HTML content on the display device per the instruction.

2. The method of claim 1, wherein the HTML content is rendered directly to a screen on the display device.

3. The method of claim 1, wherein the native HTML renderer has a plugin providing specific functionality, and wherein rendering the HTML comprises making the specific functionality available in the application.

4. The method of claim 1, further comprising retrieving HTML code for the HTML content from the application, wherein the code is used in rendering the HTML content.

5. The method of claim 1, wherein the application, the runtime, the native HTML renderer and also another HTML renderer are implemented on a device, and wherein the runtime has another API for the application to access the other HTML renderer.

6. The method of claim 1, further comprising simulating the rendering of the HTML content on a device that has another HTML renderer and does not have the native HTML renderer.

7. The method of claim 6, further comprising configuring the API on the device so that the application accesses a selected HTML renderer instead of the other HTML renderer.

8. The method of claim 1, further comprising subsequently modifying the API to allow use of a new renderer functionality.

9. A computer program product tangibly embodied in a computer readable storage device and comprising instructions that when executed by a processor perform a method comprising:
generating, in an application, an instruction to a native HTML renderer to render HTML content on a display device, the instruction generated using a runtime having an API that allows use of only at least one specified feature of the native HTML renderer; and
rendering, using the native HTML renderer, the HTML content on the display device per the instruction.

10. The computer program product of claim 9, wherein the HTML content is rendered directly to a screen on the display device.

11. The computer program product of claim 9, wherein the native HTML renderer has a plugin providing specific functionality, and wherein rendering the HTML content comprises making the specific functionality available in the application.

12. The computer program product of claim 9, further comprising retrieving HTML code for the HTML content from the application, wherein the code is used in rendering the HTML content.

13. The computer program product of claim 9, wherein the application, the runtime, the native HTML renderer and also another HTML renderer are implemented on a device, and wherein the runtime has another API for the application to access the other HTML renderer.

14. The computer program product of claim 9, further comprising simulating the rendering of the HTML content on a device that has another HTML renderer and does not have the native HTML renderer.

15. The computer program product of claim 14, further comprising configuring the API on the device so that the application accesses a selected HTML renderer on the device instead of the other HTML renderer.

16. The computer program product of claim 9, further comprising subsequently modifying the API to allow use of a new renderer functionality.

17. A system comprising:
a display device;
a native HTML renderer;
a runtime having an API for the native HTML renderer, the API allowing use of only a specified feature of the native HTML renderer; and
an application that is configured for using the API to instruct the native HTML renderer to render HTML content on the display device.

18. The system of claim 17, further comprising a plugin in the native HTML renderer that provides specific functionality, and wherein rendering the HTML content comprises making the specific functionality available in the application.

19. The system of claim 17, further comprising another HTML renderer and another API in the runtime for the application to access the other HTML renderer.

20. The system of claim 17, further comprising a device that has another HTML renderer and does not have the native HTML renderer, wherein the system simulates the rendering of the HTML content on the device.

21. The system of claim 20, wherein the API on the device is configured so that the application accesses a selected HTML renderer on the device instead of the other HTML renderer.
